(19) United States
(12) Patent Application Publication
(10) Pub. No.: US 2018/0093457 A1
(43) Pub. Date: Apr. 5, 2018

(54) RELEASE MEMBRANE FOR LEATHER PRODUCT

(71) Applicant: Ming-Hsien YAO, Siansi Township (TW)

(72) Inventor: Ming-Hsien YAO, Siansi Township (TW)

(21) Appl. No.: 15/286,213

(22) Filed: Oct. 5, 2016

(51) Int. Cl. B32B 27/08; B32B 27/36; B32B 27/30; B32B 27/32; B32B 27/40; B32B 7/12; B32B 3/30

(52) U.S. Cl. CPC B32B 27/08; B32B 27/36; B32B 27/304; B32B 27/32; B32B 2307/748; B32B 7/12; B32B 3/30; B32B 2307/308; B32B 27/40

(57) ABSTRACT

A release membrane for making stripes or figures on leather includes a substrate, which is a plastic film, an adhesive, a membrane layer attached to a surface of the substrate by means of the adhesive, and a stripe surface formed on an outer surface of the membrane layer with releasing property. The stripe surface of the membrane layer has releasing property. Alternatively, a releasing agent layer is disposed on the stripe surface of the membrane layer. By means of the release membrane, the stripes/figures can be made on the leather at lower cost.

### BACKGROUND OF THE INVENTION

### 1. Field of the Invention

The present invention relates generally to a leather product, and more particularly to a release membrane for making stripes or figures on a leather product.

### 2. Description of the Related Art

There is a conventional technique for making stripes or figures on the surface of leather. In this technique, a polyurethane (PU) material is coated on a release paper and then transferred to the substrate of the leather. The surface of the release paper is formed with stripes or figures. Therefore, the PU layer coated on the release paper is formed with the stripes or figures of the release paper. After the PU layer is transferred to the substrate of the leather, the surface of the leather has the stripes or figures.

In the conventional technique, the release paper is used as a material for making stripes or figures on the leather. In case it is desired to make different stripes or figures on the leather, it is necessary to manufacture different release papers with different stripes or figures. However, the release paper has many shortcomings, which have not been solved long since. First, the release papers for the leather are from foreign countries and controlled thereby without self-owned technique. Second, the technique and price are controlled by foreign countries so that the price of the release papers is very high. Third, when ordering the release papers, the leather manufacturers need to purchase a considerably large amount of release papers and only in this case, the seller will sell the release papers. This leads to increase of stock cost and pressure of the manufacturers. Fourth, the release paper is coated with polyethylene (PE) material so that it is impossible to recover the release paper for reuse. This is unbeneficial to environmental protection. Fifth, the release paper is manufactured by means of paper-making technique. When remaking new stripes or figures, it is necessary to remake the plate and the cost for remaking the plate is quite high and unaffordable by an ordinary manufacturer. Finally, the equipment for producing the release papers is very expensive and necessitates over several hundreds of million NTD of investment.

All the above reasons are unbeneficial to the use, design and development of new stripes or figures of the leather manufacturers. The leather manufacturers are controlled by the release paper manufacturers everywhere. This hinders the leather industries from technical upgrading. It is therefore tried by the applicant to provide the present invention to solve the shortcomings of the leather stripe technique, which have existed long since.

### SUMMARY OF THE INVENTION

It is therefore a primary object of the present invention to provide a release membrane for leather product instead of the conventional release papers purchased from foreign countries, whereby the technique of leather stripe industries can be upgraded.

It is a further object of the present invention to provide the above release membrane for leather product. The expensive release paper is replaced with the more competitive release membrane so as to lower the cost.

To achieve the above and other objects, the release membrane for leather product of the present invention includes:

a substrate, which is a film made of plastic material, the substrate being able to bear a temperature of at least 110° C.;

an adhesive;

a membrane layer made of plastic material, the membrane layer being able to bear a temperature of at least 110° C., the membrane layer being attached to a surface of the substrate by means of the adhesive;

a stripe surface formed on an outer surface of the membrane layer; and

a release agent layer disposed on the stripe surface.

Alternatively, the release membrane for leather product of the present invention includes:

a substrate, which is a film made of plastic material, the substrate being able to bear a temperature of at least 110° C.;

an adhesive;

a membrane layer made of plastic material, the membrane layer being able to bear a temperature of at least 110° C., the membrane layer being attached to a surface of the substrate by means of the adhesive; and

a stripe surface formed on an outer surface of the membrane layer, a plastic material with releasing property being added to the membrane layer as a composition thereof.

Accordingly, the present invention provides a release membrane for leather product instead of the conventional release paper. The production equipment of the release membrane is relatively cheap and is able to make finer stripes on the leather. In addition, the cost of the development of new stripes is low and the waste of the material for test production is reduced. Therefore, the domestic enterprises are easy and able to produce the release membrane so as to expedite technical upgrading. Also, the release membrane is recoverable for reuse.

Preferably, the substrate is a polyethylene terephthalate (PET) membrane. The membrane layer with releasing property is a cast polypropylene (CPP) membrane or a polyethylene (PE) membrane.

Preferably, the substrate and the membrane layer with releasing property are able to bear a temperature of at least 110° C.

Preferably, the stripe surface is formed with raised/recessed stripes.

Preferably, the release agent layer has a composition of silica gel or resin with releasing property.

Preferably, the membrane layer used in the second or third release membrane is an oriented polypropylene (OPP) membrane, a thermoplastic polyurethane (TPU) membrane or a polyvinyl chloride (PVC) membrane.

The present invention can be best understood through the following description and accompanying drawings, wherein:

### BRIEF DESCRIPTION OF THE DRAWINGS

FIG. 1 is a perspective view of a first embodiment of the release membrane of the present invention, showing a small area of release membrane as an example;

FIG. 2 is a high-power enlarged sectional view of the release membrane of FIG. 1;

FIG. 3 is a sectional view of a semi-product of the first embodiment of the release membrane of the present invention;

FIG. 4 is a sectional view showing that a plastic material layer is coated on a surface of the release membrane;

FIG. 5 is a sectional view showing that the leather is attached to the plastic material layer;

FIG. 6 is a sectional view of the leather made with the stripes, showing that the plastic material layer is transferred to the surface of the leather;

FIG. 7 is an enlarged sectional view of a second embodiment of the release membrane of the present invention;

FIG. 8 is a sectional view of a semi-product of the release membrane of FIG. 7;

FIG. 9 is an enlarged sectional view of a third embodiment of the release membrane of the present invention; and

FIG. 10 is an enlarged sectional view of a fourth embodiment of the release membrane of the present invention.

### DETAILED DESCRIPTION OF THE PREFERRED EMBODIMENTS

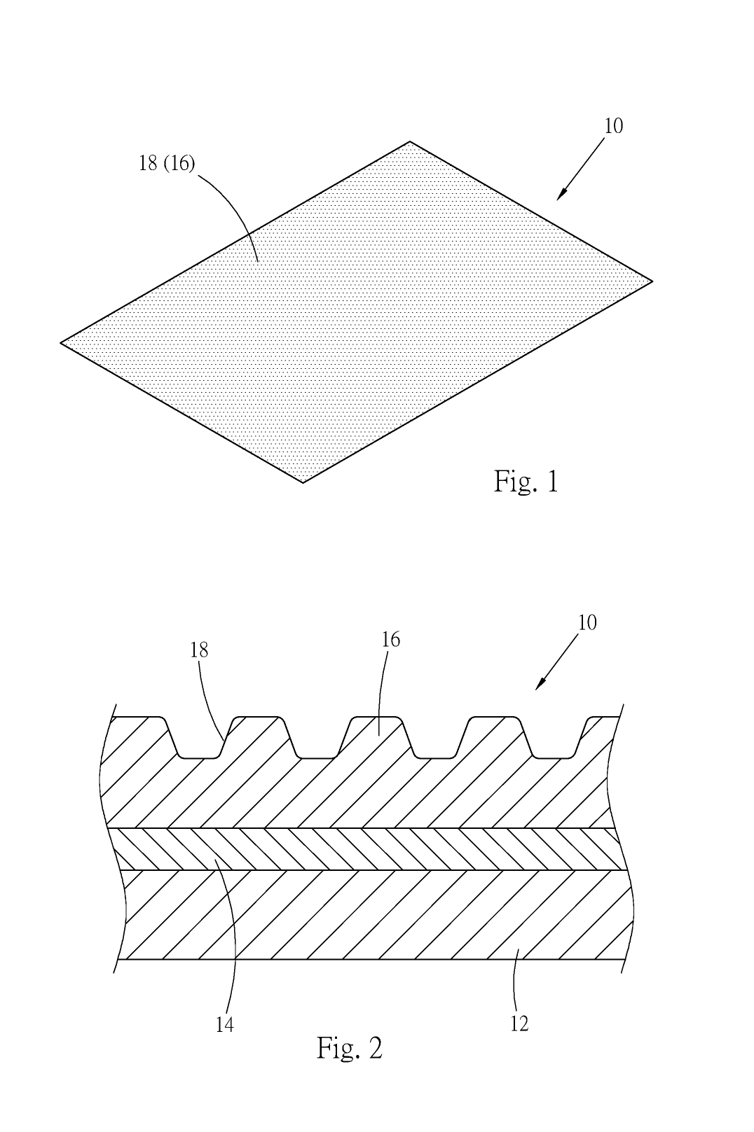

Please refer to FIG. 1. According to a first embodiment, the release membrane 10 for leather product of the present invention serves as a manufacturing material for forming stripes on the surface of the leather product.

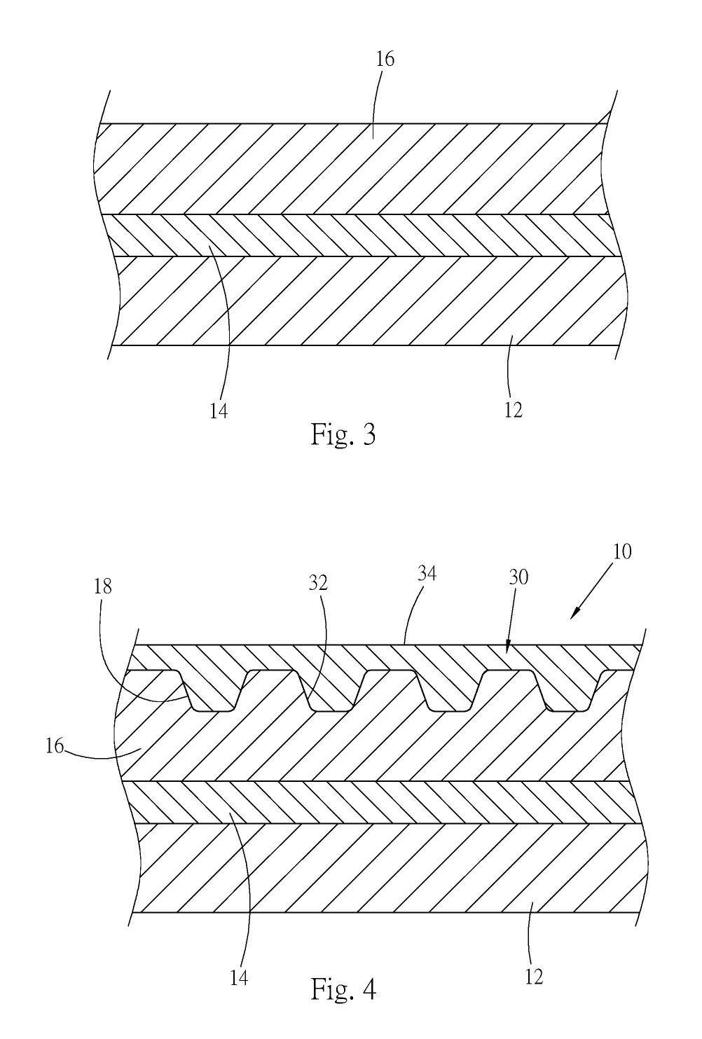

Please refer to FIG. 2. The release membrane 10 has a thickness ranging from 0.2 mm to 0.45 mm. In a preferred embodiment, the release membrane 10 has a thin thickness of 0.25 mm. The release membrane 10 is a laminate structure having a substrate 12, an adhesive 14 and a releasable membrane layer 16. The substrate is a plastic film. In this embodiment, the substrate 12 is a polyethylene terephthalate (PET) membrane. The substrate 12 (PET membrane) has high-temperature-resistant effect and is able to bear a temperature over 180 ° C.

The releasable membrane layer 16 is made of plastic material and has releasing effect. For example, the releasable membrane layer 16 can be a cast polypropylene (CPP) membrane or a polyethylene (PE) membrane. The releasable membrane layer 16 already has releasing effect without coating any release agent onto the releasable membrane layer 16, especially the CPP membrane. The releasable membrane layer 16 is able to bear a temperature over 110° C.

In this embodiment, the releasable membrane layer 16 is manufactured in such a manner that via the adhesive 14, the releasable membrane layer 16 is attached to a surface of the substrate 12. (That is, the inner surface of the releasable membrane layer 16 is adhered to the substrate). Accordingly, a semi-product of the release membrane 10 is formed as shown in FIG. 2. After the releasable membrane layer 16 is attached to the substrate 12, the releasable membrane layer 16 is embossed to form a raised/recessed stripe surface 18 on the outer surface of the releasable membrane layer 16 as shown in FIG. 2. The raised/recessed stripe surface 18 is formed by means of pressurize the releasable membrane layer 16 at high temperature. The raised/recessed stripe surface 18 can have various stripes or figures according to the design of the manufacturer. At this time, the manufacturing of the release membrane 10 is completed.

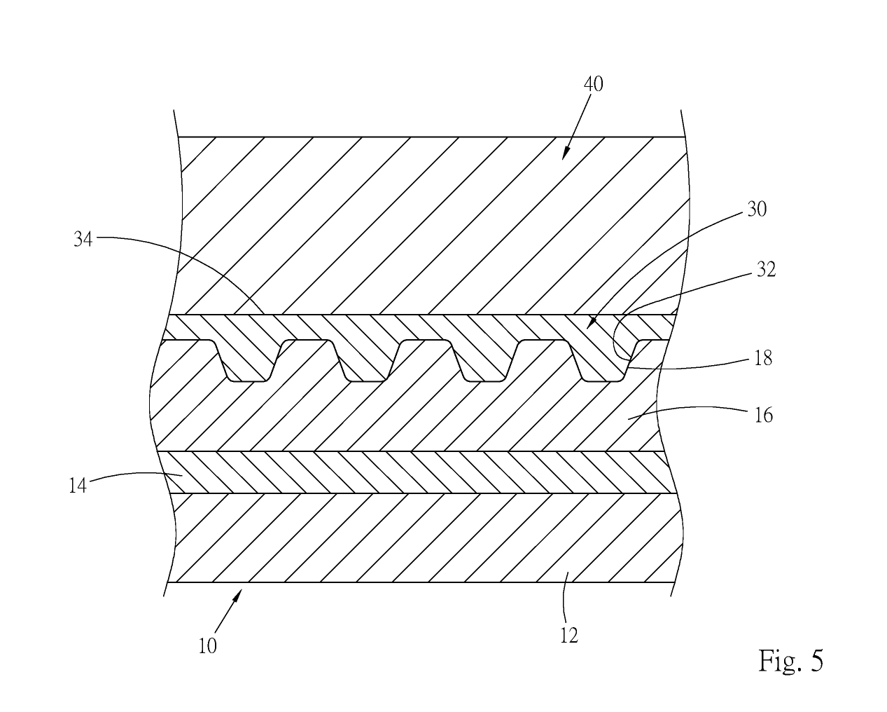

When making stripes or figures on the surface of the leather, a layer of plastic material such as polyurethane (PU) is first coated onto the raised/recessed stripe surface 18 of the releasable membrane layer 16 of the release membrane 10 to form a stripe layer 30 as shown in FIG. 4. A first surface 32 of the stripe layer 30 is formed with stripes in conformity with the raised/recessed stripe surface 18 of the releasable membrane layer 16.

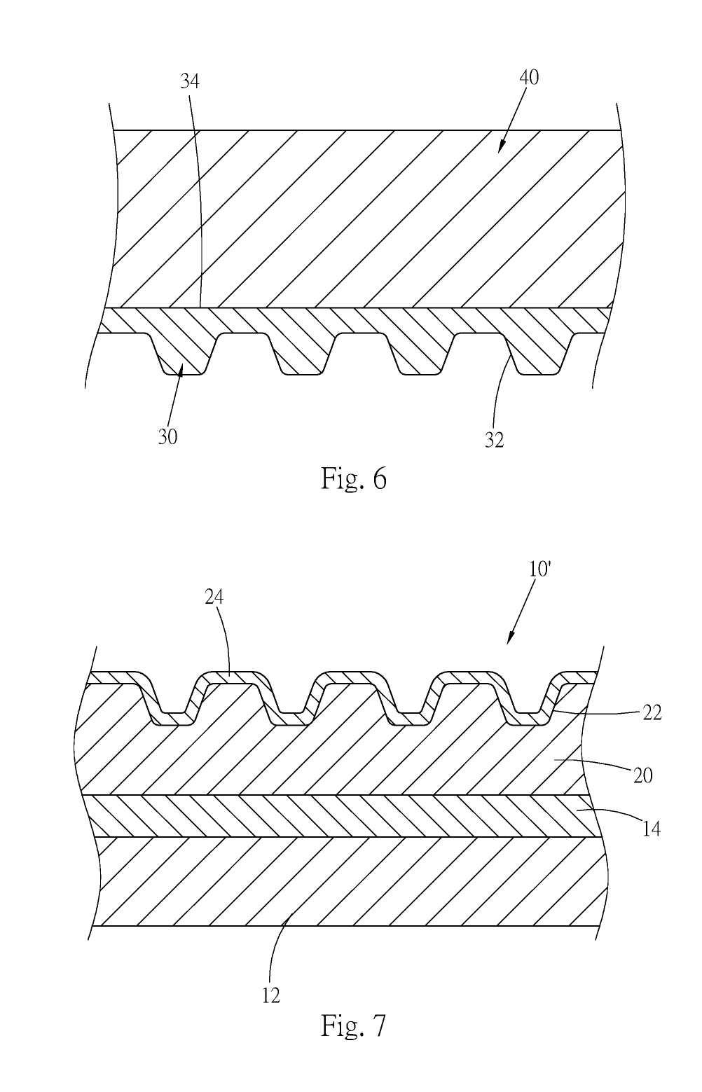

Then, as shown in FIG. 5, the leather 40 to be made with the stripes is attached to the second surface 34 of the stripe layer 30. At a high processing temperature (such as 140° C. to 160° C.), the leather 40 is bonded with the second surface 34 of the stripe layer 30. Thereafter, the leather 40 is separated from the release membrane 10. The releasable membrane layer 16 has releasing property so that the stripe layer 30 is detached from the releasable membrane layer 16 along with the leather 40. At this time, the stripes or figures on the first surface 32 of the stripe layer 30 become the stripes of the leather 40 as shown in FIG. 6. The leather to which the release membrane of the present invention is applied can be natural leather or artificial leather made of PU, polyvinyl chloride (PVC) or thermoplastic polyurethane (TPU).

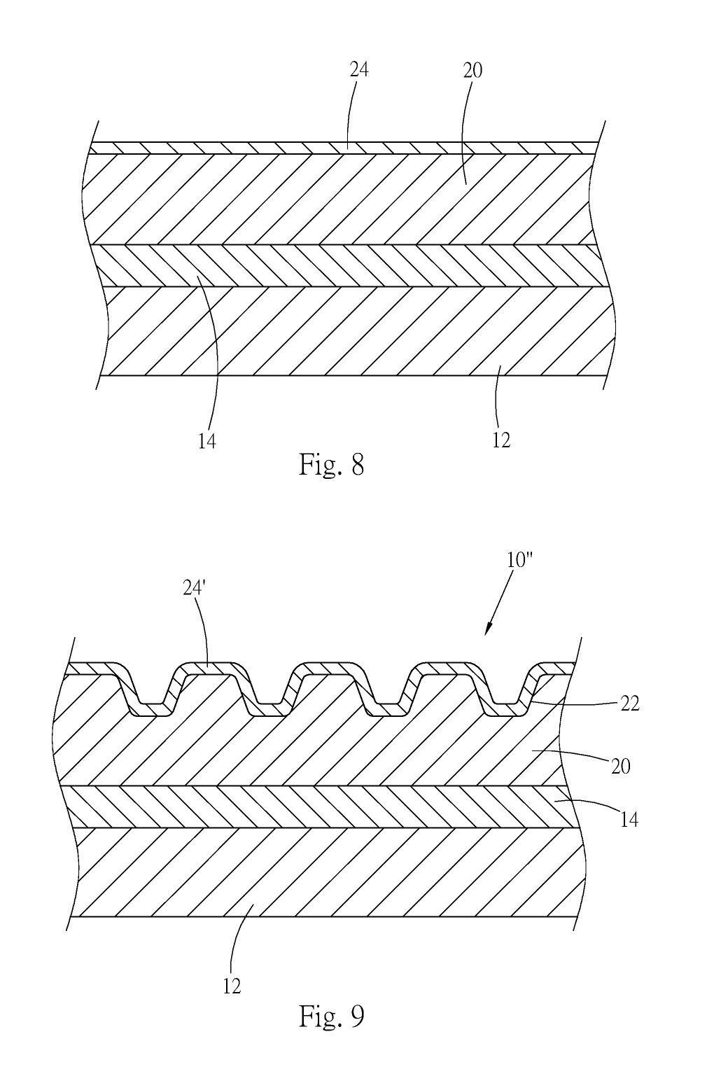

FIG. 7 is a sectional view of a second embodiment of the release membrane 10′ of the present invention. The same components are denoted with the same reference numerals. Referring to FIG. 2, the release membrane 10′ is also a laminate structure having a substrate 12, an adhesive 14 and a membrane layer 20 attached to each other. In this embodiment, the substrate 12 is also a PET membrane with high-temperature-resistance. The material of the membrane layer 20 is not limited to plastic material with releasing property. For example, the membrane layer 20 can be an oriented polypropylene (OPP) membrane or a TPU membrane or a PVC membrane. The release membrane further includes a release agent layer 24. In this embodiment, a silica gel is coated on outer surface of the membrane layer 20 to form the release agent layer as shown in FIG. 8. The composition of the release agent of the release agent layer 24 can be all silica gel or resin containing silica gel. The membrane layer 20 can be bonded with the release agent layer 24 by means of an adhesive (not shown). After the release agent layer (silica gel) 24 is coated on the outer surface of the membrane layer 20, the membrane layer 20 is pressurized at a high working temperature to form a stripe surface 22 with stripes on the outer surface of the membrane 20. The release agent layer 24 is formed on the stripe surface 22 so that the stripe surface 22 has releasing effect.

When making stripes or figures on the surface of the leather, as shown in FIGS. 4 to 6, a layer of plastic material is coated onto the stripe surface 22 of the membrane layer 20 of the release membrane 10′ to form a stripe layer. A first surface of the stripe layer is formed with stripes in conformity with the stripes of the stripe surface 22. Then, the leather to be made with the stripes is attached to the second surface of the stripe layer. At a processing temperature, the leather is bonded with the second surface of the stripe layer. Finally, the leather is separated from the release membrane 10′. Due to the releasing property of the release agent layer 24 on the surface of the membrane layer 20, the stripe layer is detached from the membrane layer 20. At this time, the stripes or figures of the first surface of the stripe layer become the stripes of the leather.

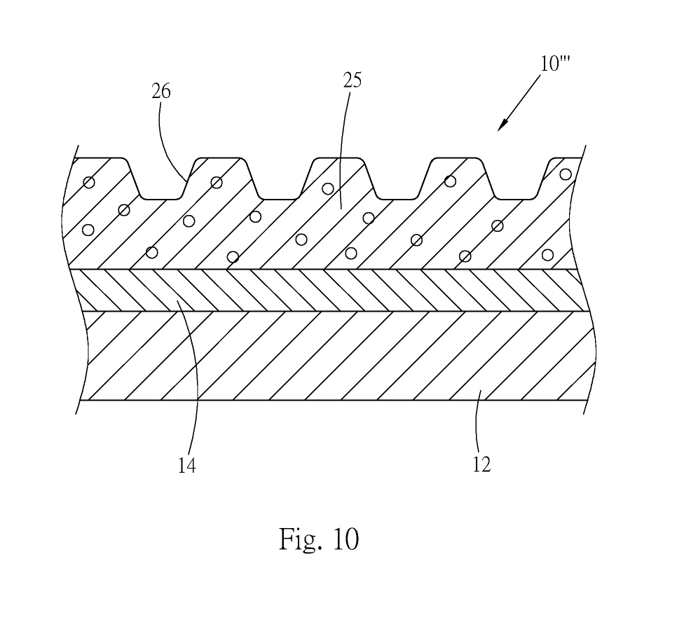

FIG. 9 is a sectional view of a third embodiment of the release membrane 10″ of the present invention. The same components are denoted with the same reference numerals. Referring to FIG. 2, the release membrane 10″ is also a laminate structure having a substrate 12, an adhesive 14 and a membrane layer 20 attached to each other. The substrate 12 and the membrane layer 20 are identical to those of the second embodiment and thus will not be repeatedly described hereinafter.

In this embodiment, the release membrane also has a release agent layer 24′ coated on the stripe surface 22 of the membrane layer 20. The release agent layer 24′ is resin with releasing property, that is, the release agent layer 24′ is made of resin as the release agent, whereby the stripe surface 22 of the membrane layer 20 has releasing property. Similarly, when making stripes or figures on the surface of the leather with the release membrane 10″, the steps of FIGS. 4 to 6 are repeated.

FIG. 10 is a sectional view of a fourth embodiment of the release membrane 10″′ of the present invention. The same components are denoted with the same reference numerals. Referring to FIG. 2, the release membrane 10″′ is also a laminate structure composed of a substrate 12, an adhesive 14 and a membrane layer 25.

The material of the membrane layer 25 can be any of the materials of the aforesaid embodiments, for example, hard PVC. Furthermore, plastic material such as silicone with releasing property is added to the membrane layer 25 as a composition thereof. The outer surface of the membrane layer is also pressurized at high temperature to form a stripe surface 26. The membrane layer 25 has the composition of silicone so that the membrane layer 25 has releasing property. In this case, the plastic material layer coated on the stripe surface 26 is easy to separate from the membrane layer 25.

The release membrane of the present invention is manufactured by the following critical techniques:
1. Due to the characteristic of plasticity of plastic material, the release membrane can be embossed to form the stripes.
2. The plastic product is uneasy to provide releasing effect. The present invention is a breakthrough technique capable of providing releasing effect for the plastic product.
3. The processing temperature of leather is over 100° C. The substrate and membrane layer employed in the present invention provide high-temperature-resistant effect for the release membrane, whereby the release membrane is able to bear the processing temperature in making the stripes on the leather.

The release membrane of the present invention is manufactured with novel material and structure instead of the conventional release paper. The release membrane of the present invention has the following advantages:
1. The stripes of the release membrane enable the leather to have finer and more sophisticated stripes.
2. The release membrane of the present invention can be produced by small-scale. Therefore, it is unnecessary to mass-order the conventional release papers for the release paper manufacturer to mass-produce the release papers. In this case, the economic burden of the stock cost, stock space of the warehouse, etc. of the leather processor can be reduced.
3. The production equipment for the release membrane of the present invention will only cost about two million NTD. In comparison with the production equipment of the conventional release papers that often costs over several hundreds of million NTD, the manufacturing technique of the release membrane of the present invention can be more popularized and utilized by small and medium enterprises to speed upgrading of technique.
4. The cost for using the release membrane to make new stripes or figures on the leather is extremely low and the speed of the development for changing the stripes or figures is fast.
5. The waste of the material for test production of the release paper is very great. In contrast, the waste of the material for test production of the release membrane is very small. They are incomparable.
6. The release papers can be replaced with the release membranes to make the stripes on the leather. In this case, the small and medium enterprises are free from the control of foreign large manufacturers.
7. The release membrane of the present invention is made of plastic material and is recoverable for reuse. This meets the requirement of environmental protection.

The structure and manufacturing principle of the release membrane of the present invention are not complicated, but are novel technique in the field of leather processing for overcoming the shortcomings and inconvenience of the conventional release paper. The use popularity ratio of the release membrane of the present invention is increased and the upgrading of industries is expedited.

The above embodiments are only used to illustrate the present invention, not intended to limit the scope thereof. Many modifications of the above embodiments can be made without departing from the spirit of the present invention.

What is claimed is:

1. A release membrane for leather product, comprising:
a substrate, which is a film made of plastic material, the substrate being able to bear a temperature of at least 110° C.;
an adhesive;
a membrane layer made of plastic material, the membrane layer being able to bear a temperature of at least 110° C., the membrane layer being attached to a surface of the substrate by means of the adhesive;
a stripe surface formed on an outer surface of the membrane layer; and
a release agent layer disposed on the stripe surface.

2. The release membrane as claimed in claim 1, wherein the release agent layer has a composition of silica gel or resin with releasing property.

3. The release membrane as claimed in claim 1, wherein there is an adhesive between the release agent layer and the membrane layer.

4. The release membrane as claimed in claim 1, wherein the membrane layer is selected from a group consisting of an oriented polypropylene (OPP) membrane, a thermoplastic polyurethane (TPU) membrane and a polyvinyl chloride (PVC) membrane.

5. The release membrane as claimed in claim 2, wherein the membrane layer is selected from a group consisting of an oriented polypropylene (OPP) membrane, a thermoplastic polyurethane (TPU) membrane and a polyvinyl chloride (PVC) membrane.

6. The release membrane as claimed in claim 3, wherein the membrane layer is selected from a group consisting of an oriented polypropylene (OPP) membrane, a thermoplastic polyurethane (TPU) membrane and a polyvinyl chloride (PVC) membrane.

7. The release membrane as claimed in claim 1, wherein the substrate is a polyethylene terephthalate (PET) membrane.

8. A release membrane for leather product, comprising:
a substrate, which is a film made of plastic material, the substrate being able to bear a temperature of at least 110° C.;
an adhesive;
a membrane layer made of plastic material, the membrane layer being able to bear a temperature of at least 110° C., the membrane layer being attached to a surface of the substrate by means of the adhesive;
a stripe surface formed on an outer surface of the membrane layer; and
a plastic material with releasing property being added to the membrane layer as a composition thereof.

9. The release membrane as claimed in claim 8, wherein the membrane layer has a composition of silica gel.

10. The release membrane as claimed in claim 8, wherein the substrate is a polyethylene terephthalate (PET) membrane.
